(19) United States
(12) Patent Application Publication
(10) Pub. No.: US 2017/0056141 A1
(43) Pub. Date: Mar. 2, 2017

(54) Dental Floss Dispensing Assembly

(71) Applicant: Catherine Haapala, Suquamish, WA (US)

(72) Inventor: Catherine Haapala, Suquamish, WA (US)

(21) Appl. No.: 14/833,235

(22) Filed: Aug. 24, 2015

(51) Int. Cl. A61C 15/04

(52) U.S. Cl. CPC A61C 15/043

(57) ABSTRACT

A dental floss dispensing assembly includes a housing that includes a top wall, a bottom wall and a perimeter wall which is attached to and extends between the top and a bottom walls. The top wall is convexly arcuate and has a domed shape. The perimeter wall tapers outwardly from the top wall to a central area of the housing and tapers inwardly from the central area to the bottom wall such that the perimeter wall is egg-shaped. A support is mounted within the interior of the housing and retains a spool holding dental floss such that the spool is rotatable with respect to the housing. The housing has an aperture extending therethrough and the dental floss is extendable through the aperture.

### BACKGROUND OF THE DISCLOSURE

Field of the Disclosure

The disclosure relates to floss dispensing devices and more particularly pertains to a new floss dispensing device for providing tooth floss in an aesthetically pleasing and easy to grip manner.

### SUMMARY OF THE DISCLOSURE

An embodiment of the disclosure meets the needs presented above by generally comprising a housing that includes a top wall, a bottom wall and a perimeter wall which is attached to and extends between the top and a bottom walls. The top wall is convexly arcuate and has a domed shape. The perimeter wall tapers outwardly from the top wall to a central area of the housing and tapers inwardly from the central area to the bottom wall such that the perimeter wall is egg-shaped. A support is mounted within the interior of the housing and retains a spool holding dental floss such that the spool is rotatable with respect to the housing. The housing has an aperture extending therethrough and the dental floss is extendable through the aperture.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a side perspective view of a dental floss dispensing assembly according to an embodiment of the disclosure.

FIG. 2 is a front perspective view of an embodiment of the disclosure.

FIG. 3 is an exploded view of an embodiment of the disclosure.

FIG. 4 is a rear view of an embodiment of the disclosure.

FIG. 5 is a cross-sectional view of an embodiment of the disclosure taken along line 5-5 of FIG. 1.

### DESCRIPTION OF THE PREFERRED EMBODIMENT

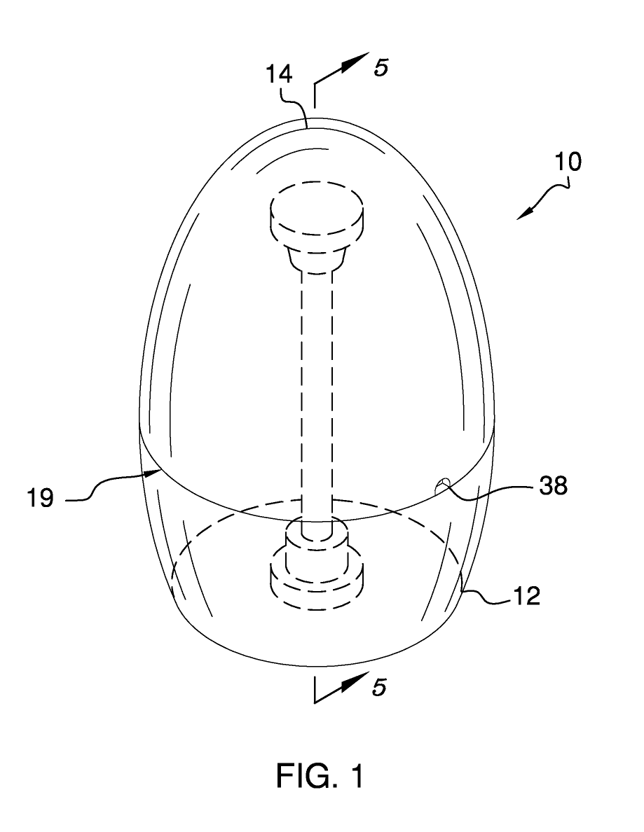

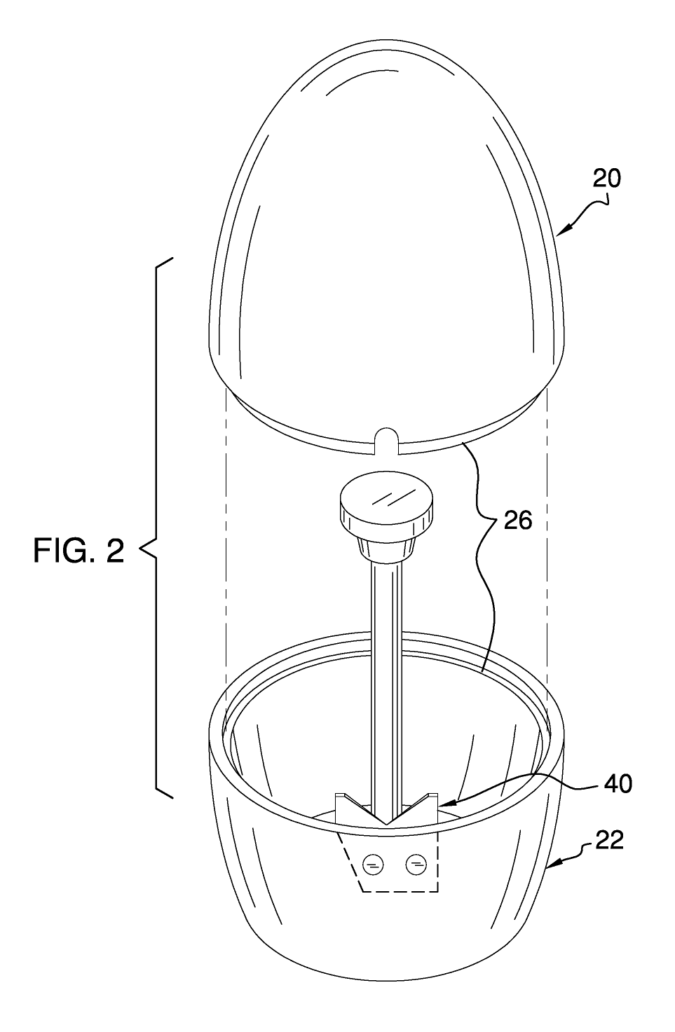

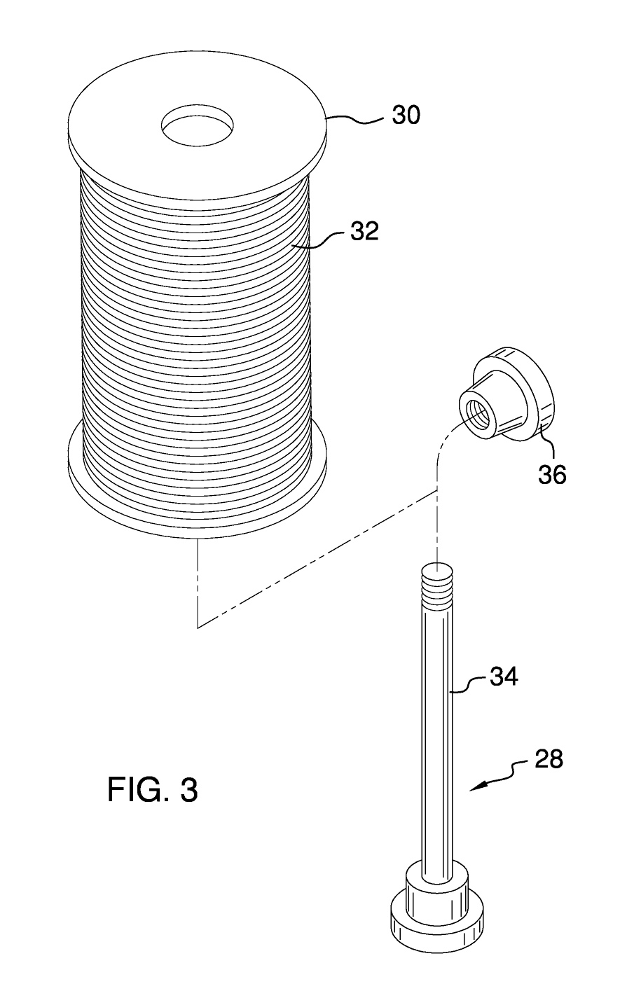

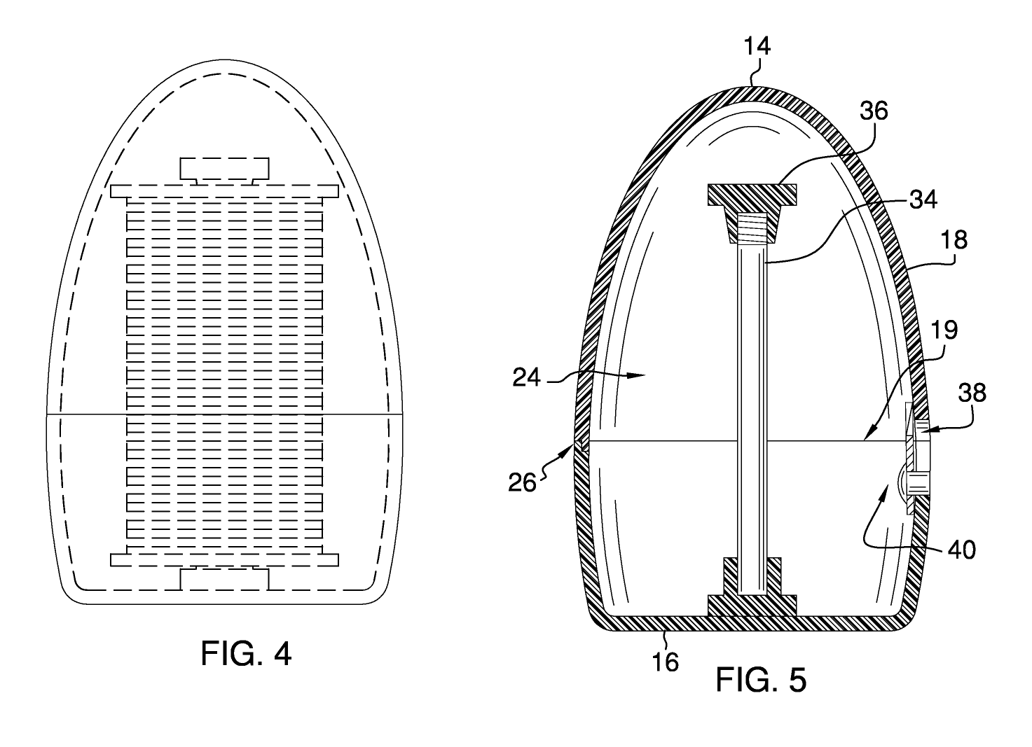

With reference now to the drawings, and in particular to FIGS. 1 through 5 thereof, a new floss dispensing device embodying the principles and concepts of an embodiment of the disclosure and generally designated by the reference numeral 10 will be described.

As best illustrated in FIGS. 1 through 5, the dental floss dispensing assembly 10 generally comprises a housing 12 having a top wall 14, a bottom wall 16 and a perimeter wall 18 that is attached to and extends downwardly therefrom. The top wall 14 is non-planar and may be convexly arcuate such that it has a domed shape. The perimeter wall 16 tapers outwardly from the top wall 14 to a central area of the housing 12 and tapers inwardly from the central area to the bottom wall 16 such that the perimeter wall 16 is egg-shaped. The bottom wall 16 is planar for stability purposes. This shape is aesthetically pleasing and easy to grip. The housing 12 may be provided in different non-rectangular configurations such as a bird, fish, shell or other non-box structure. The perimeter wall 18 has a break 19 therein such that an upper half 20 and a lower half 22 of the housing 12 are defined. The upper 20 and lower 22 halves is removably coupled together to allow access to an interior 24 of the housing 12. The upper 20 and lower 22 halves may be snap fit together with overlapping shoulders 26.

A support 28 is mounted within the interior 24 of the housing 12. The support 28 retains a spool 30 holding dental floss 32 such that the spool 30 is rotatable with respect to the housing 12. The support 28 comprises a post 34 that is attached to and extends upwardly from the bottom wall 16. The post 34 extends through the spool 30 such that the spool 30 rotates on the post 34. The post 34 may include a cap 36 that is removable from the post 34 and which retains the spool 30 on the post 34. The cap 36 may be frictionally, snappily or threadably coupled to the post 34.

The housing 12 has an aperture 38 extending therethrough and the dental floss 32 is extendable through the aperture 38. The aperture 38 may be positioned a juncture of the upper 20 and lower 22 halves. A cutting member 40 is mounted to the housing 12 adjacent to the aperture 38, wherein the cutting member 40 is configured to cut the dental floss 32 when a selected amount of the dental floss 32 has been removed from the housing 12. Though the cutting member 40 is shown as a blade mounted within the housing 12, the cutting member 40 may comprise any conventional means for breaking floss 32 utilized with dental floss dispensers and therefore may include a pair of catches mounted on the outside of the housing 12 wherein the floss 32 is wrapped around one catch and broken on the second.

In use, the assembly 10 is used in a conventional manner to allow a person to retrieve dental floss 32 from the housing 12. However, the shape of the housing 12 provides a more aesthetically pleasing containment means as well as one which is easily gripped. The assembly 10 may be re-used by opening the housing 12 and placing a new spool 30 on the post 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dental floss dispenser assembly comprising:
a housing a top wall, a bottom wall and a perimeter wall being attached to and extending between said top and bottom walls, said top wall being convexly arcuate and having a domed shape, said perimeter wall tapering outwardly from said top wall to a central area of said housing and tapering inwardly from said central area to said bottom wall such that said perimeter wall is egg-shaped;
a support being mounted within said interior of said housing, said support retaining a spool holding dental floss such that said spool is rotatable with respect to said housing; and
said housing having an aperture extending therethrough, said dental floss being extendable through said aperture.

2. The dental floss dispenser assembly according to claim 1, wherein said perimeter wall having a break therein such that an upper half and a lower half of said housing are defined, said upper and lower halves being removably coupled together to allow access to an interior of said housing.

3. The dental floss dispenser assembly according to claim 1, wherein said support comprises a post being attached to and extending upwardly from said bottom wall, said post extending through said spool such that said spool rotates on said post.

4. The dental floss dispenser assembly according to claim 1, wherein said housing having an aperture extending therethrough, said dental floss being extendable through said aperture.

5. The dental floss dispenser assembly according to claim 4, further including a cutting member being mounted to said housing adjacent to said aperture, wherein said cutting member is configured to cut said dental floss when a selected amount of said dental floss has been removed from said housing.

6. A dental floss dispenser assembly comprising:
a housing a top wall, a bottom wall and a perimeter wall being attached to and extending between said top and bottom walls, said top wall being convexly arcuate and having a domed shape, said perimeter wall tapering outwardly from said top wall to a central area of said housing and tapering inwardly from said central area to said bottom wall such that said perimeter wall is egg-shaped, said perimeter wall having a break therein such that an upper half and a lower half of said housing are defined, said upper and lower halves being removably coupled together to allow access to an interior of said housing;
a support being mounted within said interior of said housing, said support retaining a spool holding dental floss such that said spool is rotatable with respect to said housing, said support comprising a post being attached to and extending upwardly from said bottom wall, said post extending through said spool such that said spool rotates on said post;
said housing having an aperture extending therethrough, said dental floss being extendable through said aperture, said aperture being at a juncture of said upper and lower halves; and
a cutting member being mounted to said housing adjacent to said aperture, wherein said cutting member is configured to cut said dental floss when a selected amount of said dental floss has been removed from said housing.
